(19) United States
(12) Patent Application Publication
(10) Pub. No.: US 2005/0065252 A1
(43) Pub. Date: Mar. 24, 2005

(54) Acrylic resin composition

(75) Inventors: Akira Kawamura, Osaka (JP); Ryu Takeko, Ashiya-shi (JP); Tomo Iwata, Niihama-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Osaka (JP)

(21) Appl. No.: 10/934,374

(22) Filed: Sep. 7, 2004

(30) Foreign Application Priority Data
Sep. 10, 2003 (JP) 2003-317918
Apr. 30, 2004 (JP) 2004-135492

(51) Int. Cl. C08L 51/00; C08K 5/24

(52) U.S. Cl. 524/261; 525/203

(57) ABSTRACT

An acrylic resin composition comprising the following acrylic resins (1) and (2): acrylic resin (1): an acrylic resin containing a structural unit derived from a monomer (a) (structural unit (a)), a structural unit derived from a monomer (b) (structural unit (b)) and a structural unit derived from a monomer (c) (structural unit (c)) and containing the structural unit (c) in an amount of 0.05 to 5 parts by weight based on 100 parts by weight of the acrylic resin (1); acrylic resin (2): a straight chain acrylic resin containing the structural unit (a) as the main component;
(a): a (meth)acrylate of the formula (A) 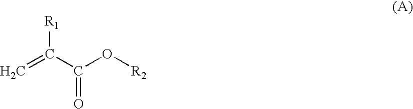
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.), (b): a monomer containing an olefinic double bond in the molecule and at least one 5- or more-membered heterocyclic group in the molecule, (c): a monomer containing at least two olefinic double bonds in the molecule.

### BACKGROUND OF THE INVENTION

1. Technical Field of the Invention

The present invention relates to an acrylic resin composition.

2. Description of the Related Art

Liquid crystal cells generally used in liquid crystal displays such as a TN liquid crystal cell (TFT), a STN liquid crystal cell (STN) and the like, have a structure in which a liquid crystal component is sandwiched between two glass base materials. On the surface of the glass base material, an optical film such as a polarizing film, phase retardation film and the like is laminated via an adhesive composed mainly of an acrylic resin. An optical laminate composed of a glass base material, adhesive and optical film laminated in this order is in general produced by a method in which first an optical laminated film having an adhesive layer composed of an adhesive laminated on an optical film is obtained, and then, a glass base material is laminated on the surface of the adhesive layer.

Such an optical laminated film tends to generate curl and the like due to large dimension change by expansion and shrinkage under heating or moistening and heating conditions, consequently, there are problems such as occurrence of foaming in an adhesive layer of the resulted optical laminate, generation of peeling between an adhesive layer and a glass base material, and the like. Under heating or moistening and heating conditions, distribution of remaining stress acting on an optical laminated film becomes non-uniform, concentration of stress occurs around peripheral parts of an optical laminate, consequently, there is a problem that light leakage occurs in a TN liquid crystal cell (TFT). For solving such problems, there is a suggestion on an adhesive mainly composed of an acrylic resin having a structural unit derived from N-vinylpyrrolidone which is a kind of monomer having a hetero-cycle in the molecule (Japanese Patent Application Laid-Open (JP-A) No. 5-107410).

However, there is a problem that, when a liquid crystal cell obtained by using an optical laminate having an adhesive layer made of an adhesive mainly composed of an acrylic resin having a structural unit derived from N-vinylpyrrolidone is preserved under moistening and heating conditions, light leakage occurs.

### DISCLOSURE OF THE INVENTION

An object of the present invention is to provide an acrylic resin composition capable of producing an optical laminated film used in a liquid crystal cell in which light leakage and non-uniformity of color are suppressed.

The present inventors have intensively studied to find an acrylic resin composition capable of solving problems as described above, and resultantly found that a liquid crystal cell obtained by using an acrylic resin composition comprising a structural unit derived from a monomer containing one olefinic double bond in the molecule and at least one 5- or more-membered heterocyclic group in the molecule and a structural unit derived from a monomer containing at least two olefinic double bonds in the molecule shows little light leakage, and have completed the present invention.

Namely, the present invention provides the following [1] to [17].

[1] An acrylic resin composition comprising the following acrylic resins (1) and (2):
acrylic resin (1): an acrylic resin containing a structural unit derived from a monomer (a) (structural unit (a)), a structural unit derived from a monomer (b) (structural unit (b)) and a structural unit derived from a monomer (c) (structural unit (c)) and containing the structural unit (c) in an amount of 0.05 to 5 parts by weight based on 100 parts by weight of the acrylic resin (1);
acrylic resin (2): a straight chain acrylic resin containing the structural unit (a) as the main component;
(a): a (meth)acrylate of the formula (A) 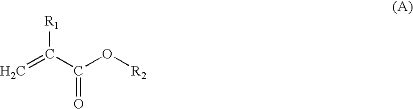
   (wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.),
(b): a monomer containing an olefinic double bond in the molecule and at least one 5-or more-membered heterocyclic group in the molecule,
(c): a monomer containing at least two olefinic double bonds in the molecule.

[2] The composition according to [1], wherein the acrylic resin (2) is an acrylic resin containing substantially no structural unit (c).

[3] The composition according to [1] or [2], wherein the content of the structural unit (a) in the acrylic resin (1) is from 15 to 99.85 parts by weight based on 100 parts by weight of the acrylic resin (1).

[4] The composition according to any of [1] to [3], wherein the content of the structural unit (b) in the acrylic resin (1) is from 0.1 to 30 parts by weight based on 100 parts by weight of the acrylic resin (1).

[5] The composition according to any of [1] to [4], wherein the monomer (b) is at least one selected from the group consisting of N-vinylpyrrolidone, vinylcaprolactam and acryloylmorpholine.

[6] The composition according to any of [1] to [5], wherein the acrylic resin (1) is an acrylic resin further containing a structural unit derived from a monomer (d):
(d): a monomer different from (a) to (c) and containing one olefinic double bond and at least one alicyclic structure in the molecule.

[7] The composition according to any of [1] to [6], wherein the acrylic resin (1) and/or (2) further contains a structural unit derived from a monomer (e):
(e): a monomer different from (a) to (d) and containing at least one polar functional group selected from the group consisting of a carboxyl group, hydroxyl group, amide group, amino group, epoxy group, oxetanyl group, aldehyde group and isocyanate group and one olefinic double bond in the molecule.

[8] The composition according to any of [1] to [7], wherein the monomer (c) is a monomer containing in the molecule at least two (meth)acryloyl groups of the formula (B): 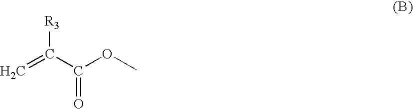
(wherein, R₃ represents a hydrogen atom or methyl group.).

[9] The composition according to any of [1] to [8], wherein the amount of the acrylic resin (1) is 5 to 50 parts by weight based on 100 parts by weight of the total amount of the acrylic resin (1) and the acrylic resin (2).

[10] An adhesive comprising the composition according to any of [1] to [9] and a cross-linking agent and/or silane-based compound.

[11] An optical laminated film laminating an adhesive layer composed of the adhesive according to [10] on both surfaces or one surface of an optical film.

[12] The optical laminated film according to [11], wherein the optical film is a polarizing film and/or phase retardation film.

[13] The optical laminated film according to [11] or [12], wherein the optical film is an optical film further having an acetylcellulose-based film as a protective film.

[14] The optical laminated film according to any of [11] to [13], wherein a release film is further laminated on the adhesive layer of the optical laminated film.

[15] An optical laminate obtained by laminating a glass base material on the adhesive layer of the optical laminated film according to any of [11] to [13].

[16] An optical laminate obtained by peeling the release film from the optical laminated film according to [14], then, laminating a glass base material on the adhesive layer of the optical laminated film.

[17] An optical laminate obtained by peeling the optical laminated film from the optical laminate according to [15] or [16], then, laminating again the optical laminated film on the resulted glass base material.

The present invention will be described in detail below.

The acrylic resin composition of the present invention comprises the acrylic resin (1) and the acrylic resin (2) described above.

The acrylic resin (1) is a resin containing a structural unit derived from a monomer (a) (structural unit (a)), a structural unit derived from a monomer (b) (structural unit (b)) and a structural unit derived from a monomer (c) (structural unit (c)). The acrylic resin (2) is a straight chain acrylic resin containing the structural unit (a) as the main component.

The monomer (a) is a (meth)acrylate of the following formula (A):

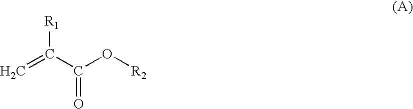

Wherein, R₁ represents a hydrogen atom or methyl group, R₂ represents an alkyl group having 1 to 14 carbon atoms or an aralkyl group having 1 to 14 carbon atoms. A hydrogen atom in the alkyl group R₂ or a hydrogen atom in the aralkyl group R₂ may be substituted with an alkoxy group having 1 to 10 carbon atoms.

Examples of the alkyl group having 1 to 14 carbon atoms include a methyl group, ethyl group, propyl group, butyl group, hexyl group, octyl group, nonyl group, decyl group and the like.

Examples of the aralkyl group having 1 to 14 carbon atoms include a benzyl group, phenetyl group, benzhydryl group, trityl group and the like.

Examples of the alkoxy group having 1 to 10 carbon atoms which may be a substituent of R₂ include a methoxy group, ethoxy group, butoxy group and the like.

Examples of the monomer (a) include acrylates such as methyl acrylate, ethyl acrylate, propyl acrylate, n-butyl acrylate, iso-butyl acrylate, 2-ethylhexyl acrylate, n-octyl acrylate, iso-octyl acrylate, lauryl acrylate, stearyl acrylate, cyclohexyl acrylate, isobornyl acrylate, benzyl acrylate, methoxyethyl acrylate and ethoxylmethyl acrylate and the like; and methacrylates such as methyl methacrylate, ethyl methacrylate, propyl methacrylate, n-butyl methacrylate, iso-butyl methacrylate, 2-ethylhexyl methacrylate, n-octyl methacrylate, iso-octyl methacrylate, lauryl methacrylate, stearyl methacrylate, cyclohexyl methacrylate, isobornyl methacrylate, benzyl methacrylate, methoxyethyl methacrylate, ethoxymethyl methacrylate and the like.

The monomer (a) may be used alone or in admixture of two or more.

The content of a structural unit derived from the monomer (a) (structural unit (a)) in the acrylic resin (1) is usually from about 15 to 99.85 parts by weight, and preferably from about 70 to 95 parts by weight based on 100 parts by weight of the acrylic resin (1). The content of a structural unit derived from the monomer (a) (structural unit (a)) in the acrylic resin (2) is usually from about 65 to 100 parts by weight based on 100 parts by weight of the acrylic resin (2).

A structural unit derived from the monomer (b) (structural unit (b)) is an essential component of the acrylic resin (1) and may be contained as an optional component in the acrylic resin (2).

Here, the monomer (b) is a monomer containing one olefinic double bond in the molecule and at least one 5- or more-membered heterocyclic group in the molecule.

The at least one 5-or more-membered heterocyclic group means a group obtained by substitution of at least one methylene group in an alicyclic hydrocarbon group having 5 or more carbon atoms, preferably 5 to 7 carbon atoms with a hetero atom such as a nitrogen atom, oxygen atom or sulfur atom.

Specific examples of the monomer (b) include acryloylmorpholine, vinylcaprolactam, N-vinyl-2-pyrrolidone, tetrahydrofurfuryl acrylate, tetrahydrofurfuryl methacrylate, caprolactone-modified tetrahydrofurfuryl acrylate, and the like. Monomers having an olefinic double bond contained in a heterocyclic group, such as 2,5-dihydrofuran and the like are included in the monomer (b).

The monomer (b) may be used alone or in combination of two or more.

As the monomer (b), N-vinylpyrrolidone, vinylcaprolactam, acryloylmorpholine, or mixtures thereof are suitably used.

The content of a structural unit derived from the monomer (b) (structural unit (b)) contained in the acrylic resin (1) is usually from about 0.1 to 30 parts by weight, and preferably from about 0.1 to 20 parts by weight based on 100 parts by weight of the acrylic resin (1). When the content of the structural unit (b) is 0.1 part by weight or more, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably, and when 30 parts by weight or less, peeling between a glass base material and an adhesive layer tends to be suppressed preferably.

The monomer (c) used in the acrylic resin (1) is a monomer containing at least two olefinic double bonds in the molecule. By the presence of this monomer (c), main chains constituted of structural units (a) and (b) and the like of the acrylic resin (1) will be cross-linked.

Examples of the monomer (c) include monomers containing two olefinic double bonds in the molecule (bi-functional monomer), monomers containing three olefinic double bonds in the molecule (tri-functional (vinyl) monomer), monomers containing four olefinic double bonds in the molecule (tetra-functional (vinyl) monomer), and the like.

Examples of the monomer containing two olefinic double bonds in the molecule (bi-functional monomer) include (meth)acrylates such as ethylene glycol di(meth)acrylate, diethylene glycol di(meth)acrylate and the like, bis(meth)acrylamides such as methylenebis(meth)acrylamide, ethylenebis(meth)acrylamide and the like, divinyl esters such as divinyl adipate, divinyl sevacate and the like, allyl methacrylate, divinylbenzene and the like.

Examples of the monomer containing three olefinic double bonds in the molecule (tri-functional (vinyl) monomer) include 1,3,5-triacryloylhexahydro-S-triazine, triallyl isocyanurate, triallylamine, N,N-diallylacrylamide, trimethylolpropane triacrylate, trimethylolpropane trimethacrylate and the like.

Examples of the monomer containing four olefinic double bonds in the molecule (tetra-functional (vinyl) monomer) include tetramethylolmethane tetraacrylate, tetraallyl pyromellitate, N,N,N′,N′-tetraallyl-1,4-diaminobutane, tetraallyl ammonium salt and the like.

The monomer (c) may be used alone or in admixture of two or more.

Among monomers (c), monomers having two (meth)acryloyl groups in the molecule of the following formula (B) are preferably used.

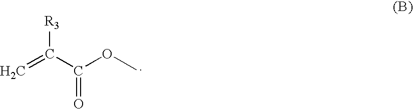

In the formula, R₃ represents a hydrogen atom or methyl group.

The content ([c−1]) of a structural unit derived from the monomer (c) in the acrylic resin (1) is from 0.05 to 5 parts by weight, preferably from about 0.1 to 3 parts by weight based on 100 parts by weight of all structural units constituting the acrylic resin (1). When [c−1] is 0.05 parts by weight or more, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably, and when 5 parts by weight or less, production of gel in producing an acrylic resin tends to be suppressed preferably.

The acrylic resin (2) used in the present invention is a straight chain acrylic resin containing the structural unit (a) as a main component, and preferably an acrylic resin containing as an essential component the structural unit (a) and containing as an optional component the structural unit (c) in an amount of not more than one-fifth of the content (weight) of the structural unit (c) contained in the acrylic resin (1), and more preferably an acrylic resin containing substantially no structural unit (c). The content ([c−2]) of the structural unit (c) in the acrylic resin (2) and the content ([c−1]) of the structural unit (c) in the acrylic resin (1) are represented by the following formula.
[c−2]/[c−1]≦⅕

Particularly, the content of the structural unit (c) in the acrylic resin (2) is preferably 0.02 parts by weight or less, more preferably 0.01 part by weight or less based on 100 parts by weight of all structural units constituting the acrylic resin (2). It is preferable that the acrylic resin (2) is a straight chain acrylic resin since peeling between an adhesive layer containing the acrylic resin composition of the present invention and a glass base plate tends to be suppressed.

The acrylic resin (1) of the present invention may further contain a structural unit derived from a monomer (d) (structural unit (d)). Here, the monomer (d) is a monomer different from monomers (a) to (c) and containing one olefinic double bond and at least one alicyclic structure in the molecule. This alicyclic structure is usually a cycloparaffin structure or cycloolefin structure having 5 or more carbon atoms, preferably about 5 to 7 carbon atoms, and in the cycloolefin structure, an olefinic double bond is contained in the alicyclic structure.

Examples of the monomer (d) include acrylates having an alicyclic structure, methacrylates having an alicyclic structure, acrylates having a plurality of alicyclic structures, vinylcyclohexyl acetate containing a vinyl group, and the like.

Examples of the acrylate having an alicyclic structure include isobornyl acrylate, cyclohexyl acrylate, dicyclopentanyl acrylate, cyclododecyl acrylate, methylcyclohexyl acrylate, trimethylcyclohexyl acrylate, tert-butylcyclohexyl acrylate, cyclohexyl-α-ethoxy acrylate, cyclohexyl phenyl acrylate and the like.

Examples of the methacrylate having an alicyclic structure include isobornyl methacrylate, cyclohexyl methacrylate, dicyclopentanyl methacrylate, cyclododecyl methacrylate, methylcyclohexyl methacrylate, trimethylcyclohexyl methacrylate, tert-butylcyclohexyl methacrylate, cyclohexyl-α-ethoxy methacrylate, cyclohexyl phenyl methacrylate and the like.

Examples of the acrylate having a plurality of alicyclic structures include biscyclohexyl methyl itaconate, dicyclooctyl itaconate, dicyclododecyl methyl succinate and the like.

The monomer (d) may be used alone or in combination of two or more.

When the monomer (d) is used in the acrylic resin (1), the content of the structural unit (d) contained in the acrylic resin (1) is usually from about 0.1 to 30 parts by weight, preferably from about 1 to 15 parts by weight based on 100 parts by weight of the acrylic resin (1). When the content of the structural unit (d) is 0.1 part by weight or more, peeling between a glass base plate and an adhesive layer tends to be suppressed preferably, and when 30 parts by weight or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

As the monomer (d), isobornyl acrylate, cyclohexyl acrylate, isobornyl methacrylate, cyclohexyl methacrylate and dicyclopentanyl acrylate are preferable due to easy availability.

The acrylic resin (1) and/or (2) used in the present invention may contain a structural unit (structural unit (e)) derived from the monomer (e) different from (a) to (d) and containing one olefinic double bond and a polar functional group such as a carboxyl group, hydroxyl group, amino group, amide group, epoxy group, oxetanyl group, aldehyde group, isocyanate group or the like in the molecule. Particularly, it is preferable that the acrylic resin (2) contains the structural unit (e). It is preferable that the structural unit (e) is contained since then the acrylic resin composition of the present invention is cross-linked as a polar functional group with a cross-linking agent described later.

Specific examples of the monomer (e) include monomers in which a polar functional group is a carboxyl group such as acrylic acid, methacrylic acid, maleic acid, itaconic acid and the like, monomers in which a polar functional group is a hydroxyl group such as 2-hydroxyethyl (meth)acrylate, 2-hydroxypropyl (meth)acrylate, 4-hydroxybutyl (meth)acrylate and the like, monomers in which a polar functional group is an amide group such as acrylamide, methacrylamide, N,N-dimethylaminopropylacrylamide, diacetonediamide, N,N-dimethylacrylamide, N,N-diethylacrylamide, N-methylolacrylamide and the like, monomers in which a polar functional group is an epoxy group such as glycidyl acrylate, glycidyl methacrylate and the like, monomers in which a polar functional group is an oxetany group such as oxetanyl (meth)acrylate, 3-oxetanylmethyl (meth)acrylate, (3-methyl-3-oxetanyl)methyl (meth)acrylate, (3-ethyl-3-oxetanyl)methyl (meth)acrylate and the like, monomers in which a polar functional group is an amino group such as N,N-dimethylaminoethyl acrylate, allylamine and the like, monomers in which a polar functional group is an isocyanate group such as 2-methacryloyloxyethyl isocyanate and the like, monomers in which a polar functional group is an aldehyde group such as acrylaldehyde and the like. The monomer (e) may be used alone or in combination of two or more.

As the monomer (e), monomers in which a polar functional group is a hydroxyl group are preferable, and 4-hydroxybutyl (meth)acrylate is suitably used.

When the acrylic resin (1) contains the structural unit (e), the content of the structural unit (e) in the acrylic resin (1) is usually from about 0 to 20 parts by weight based on 100 parts by weight of the acrylic resin (1). When the content of the structural unit (e) is 20 parts by weight or less, floating peeling between a glass base plate and an adhesive layer tends to be suppressed preferably.

When the acrylic resin (2) contains the structural unit (e), the content of the structural unit (e) in the acrylic resin (2) is usually from about 0.05 to 20 parts by weight, preferably from about 0.1 to 15 parts by weight based on 100 parts by weight of the acrylic resin (2). When the content of the structural unit (e) is 0.05 parts by weight or more, the cohesive force of the resulting resin tends to increase preferably, and when 20 parts by weigh or less, peeling between a glass base plate and an adhesive layer tends to be suppressed preferably.

The acrylic resin (1) and/or (2) used in the present invention may contain a vinyl-based monomer (f) different from any of the monomers (a) to (e). Examples of the vinyl-based monomer include fatty vinyl esters, halogenated vinyls, halogenated vinylidenes, aromatic vinyls, (meth)acrylonitrile, conjugated diene compounds and the like.

Examples of the fatty vinyl ester include vinyl acetate, vinyl propionate, vinyl butyrate, vinyl 2-ethylhexanoate, vinyl laurate and the like.

Examples of the halogenated vinyl include vinyl chloride, vinyl bromide and the like.

Examples of the halogenated vinylidene include vinylidene chloride and the like.

Examples of the (meth)acrylonitrile include acrylonitril, methacrylonitrile and the like.

The conjugated diene compound is an olefine having a conjugated double bond in the molecule, and specific examples thereof include isoprene, butadiene, chloroprene and the like. The aromatic vinyl is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene and the like, nitrogen-containing aromatic vinyls such as vinylpyridine, vinyl carbazole and the like. The vinyl-based monomer (f) may be used alone or in combination of two or more.

The content of the structural unit (f) derived from the monomer (f) contained in the acrylic resin (1) is usually 5 parts by weight or less, preferably 0.05 parts by weight or less based on 100 parts by weight of all structural units constituting the acrylic resin (1), and it is more preferable that the structural unit (f) is not substantially contained. The content of the structural unit (f) contained in the acrylic resin (2) is usually 5 parts by weight or less, preferably 0.05 parts by weight or less based on 100 parts by weight of all structural units constituting the acrylic resin (2), and it is more preferable that the structural unit (f) is not substantially contained.

As the method of producing the acrylic resin (1) and (2) used in the present invention, for example, a solution polymerization method, emulsion polymerization method, block polymerization method, suspension polymerization method and the like are listed. In production of an acrylic resin, a polymerization initiator is usually used. The polymerization initiator is used in an amount of about 0.001 to 5 parts by weight based on 100 parts by weight of all monomers used in production of an acrylic resin.

As the polymerization initiator, for example, a heat-polymerization initiator, photo-polymerization initiator, and the like are listed.

Examples of the photo-polymerization initiator include 4-(2-hydroxyethoxy)phenyl(2-hydroxy-2-propyl)ketone and the like.

Examples of the heat-polymerization initiator include azo-based compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaletonitrile), dimethyl-2,2′-azobis(2-methyl propionate), 2,2′-azobis(2-hydroxymethylpropionitrile) and the like; organic peroxides such as lauryl peroxide, tert-butyl hydroperoxide, benzoyl peroxide, tert-butyl peroxybenzoate, cumene hydroperoxide, diisopropyl peroxy dicarbonate, di-n-propyl peroxydicarbonate, tert-butyl peroxyneodecanoate, tert-butyl peroxypivalate, (3,5,5-trimethylhexanonyl) peroxide and the like; inorganic peroxides such as potassium persulfate, ammonium persulfate, hydrogen peroxide and the like. Redox-based initiators using a heat-polymerization initiator and a reducing agent together can also be used as a polymerization initiator.

As the method of producing an acrylic resin, a solution polymerization method is preferable. Specifically mentioned as the solution polymerization method are a method in which given monomers and an organic solvent are mixed, a heat-polymerization initiator is added under a nitrogen atmosphere, and the mixture is stirred for about 3 to 10 hours at about 40 to 90° C., preferably about 60 to 80° C., and other methods. For controlling the reaction, a method in which monomers and a heat-polymerization initiator used are added during polymerization, a method in which these are dissolved in an organic solvent before addition thereof, and the like may be adopted. Here, examples of the organic solvent include aromatic hydrocarbons such as toluene, xylene and the like; esters such as ethyl acetate, methyl acetate and the like; aliphatic alcohols such as n-propyl alcohol, isopropyl alcohol and the like; ketones such as methyl ethyl ketone, methyl isobutyl ketone and the like.

The viscosity (25° C.) of a solution prepared by diluting the resulted acrylic resin (1) in ethyl acetate to a non-volatile component content of 30% is usually 10 Pa·s or less, preferably 5 Pa·s or less. When the viscosity of an acrylic resin is 10 Pa·s or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

Regarding the molecular weight of the acrylic resin (1), the weight-average molecular weight according to a light scattering method of gel permeation chromatography (GPC) is usually 5×10⁵ or more, preferably 1×10⁶ or more. When the weight-average molecular weight is 5×10⁵ or more, adhesion under high temperature and high humidity increases, and peeling between a glass base plate and an adhesive layer tends to lower, further, a re-working property tends to be improved, preferably.

Regarding the molecular weight of the acrylic resin (2), the weight-average molecular weight according to a light scattering method of gel permeation chromatography (GPC) is usually 1×10⁶ or more, preferably 2×10⁶ to 1×10⁷. When the weight-average molecular weight is 1×10⁶ or more, adhesion under high temperature and high humidity increases, and peeling between a glass base plate and an adhesive layer tends to lower, further, a re-working property tends to be improved, preferably. When the weight-average molecular weight is 1×10⁷ or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

The acrylic resin composition of the present invention is a resin composition containing thus obtained acrylic resin (1) and acrylic resin (2). Regarding production thereof, usually, an acrylic resin (1) and acrylic resin (2) are separately produced, and then, mixed, or, it may also be permissible that either an acrylic resin (1) or acrylic resin (2) is produced, then, another acrylic resin is produced in the presence of the produced acrylic resin. Further, it may also be permissible that acrylic resins (1) and (2) are mixed, and then, diluted with an organic solvent.

Regarding the weight ratio (non-volatile component) in an acrylic resin composition, the ratio of the acrylic resin (1) is usually 5 parts by weight or more, preferably about 10 to 50 parts by weight based on 100 parts by weight of the total amount of the acrylic resin (1) and acrylic resin (2). When the ratio of the acrylic resin (1) is 5 parts by weight or more, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

The viscosity (25° C.) of a solution prepared by diluting an acrylic resin composition with ethyl acetate to a non-volatile component content of 20% is preferably 10 Pa·s or less, more preferably 0.1 to 7 Pa·s. When the viscosity is 10 Pa·s or less, adhesion under high temperature and high humidity increases, and peeling between a glass base plate and an adhesive layer tends to lower, further, a re-working property tends to be improved, preferably.

The acrylic resin composition of the present invention can be used as it is for an adhesive, adhesive, paint, thickening agent and the like. A composition obtained by compounding a cross-linking agent and/or silane-based compound in the acrylic resin composition of the present invention is suitable as an adhesive.

Here, the cross-linking agent has in the molecule two or more functional groups capable of cross-linking with a polar functional group, and specific examples thereof include isocyanate-based compounds, epoxy-based compounds, metal chelate-based compounds, aziridine-based compounds and the like.

Here, examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate and the like, and adducts obtained by reacting polyols such as glycerol, trimethylolpropane and the like with the above-mentioned isocyanate compounds, and those obtained by converting the isocyanate compounds into dimmers, trimers and the like, are also included.

Examples of the epoxy-based compound include bisphenol A type epoxy resin, ethylene glycol glycidyl ether, polyethylene glycol diglycidyl ether, glycerine glycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis(N,N′-diglycidylaminomethyl)cyclohexane and the like.

Examples of the metal chelate compound include compounds obtained by coordinating acetylacetone or ethyl acetoacetate on poly-valent metals such as aluminum, iron, copper, zinc, tin, titanium, nickel, antimony, magnesium, vanadium, chromium, zirconium and the like.

Examples of the aziridine-based compound include N,N′-diphenylmethane-4,4′-bis(1-aziridine carboxide), N,N′-toluene-2,4-bis(1-aziridine carboxamide), triethylenemelamine, bisisophthaloyl-1-(2-methylaziridine), tri-1-aziridinylphosphine oxide, N,N′-hexamethylene-1,6-bis(1-aziridine carboxide), trimethylolpropane-tri-β-aziridinyl propionate, tetramethylolmethane-tri-β-aziridinyl propionate, and the like.

The cross-linking agent may be used alone or in combination of two or more. The use amount of a cross-linking agent (non-volatile component) in an adhesive is usually from about 0.005 to 5 parts by weight, preferably from about 0.01 to 3 parts by weight based on 100 parts by weight of an acrylic resin composition (non-volatile component). When the amount of the cross-linking agent is 0.005 parts by weight or more, peeling between a glass base plate and an adhesive layer and a re-working property tend to be improved preferably, and when 5 parts by weight or less, a property of an adhesive layer to follow the dimension change of an optical film is excellent, consequently, light leakage and non-uniformity of color tend to lower preferably.

Examples of the silane-based compound used in the adhesive of the present invention include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane and the like. In the adhesive of the present invention, two or more silane-based compounds may be used.

The use amount of the silane-based compound (solution) is usually from about 0.0001 to 10 parts by weight, preferably from 0.01 to 5 parts by weight based on 100 parts by weight of an acrylic resin composition (non-volatile component). When the amount of a silane-based compound is 0.0001 part by weight or more, adhesion between an adhesive layer and a glass base plate is improved preferably. When the amount of a silane-based compound is 10 parts by weight or less, bleeding out of a silane-based compound from the adhesive layer tends to be suppressed preferably.

The adhesive of the present invention is composed of an acrylic resin composition, cross-linking agent and/or silane-based compound as described above, and, a weather-resistant agent, tackifier, plasticizer, softening agent, dye, pigment, inorganic filler and the like may be further compounded to the adhesive of the present invention.

The optical laminated film of the present invention is obtained by laminating an adhesive layer composed of the above-mentioned adhesive on both surfaces or one surface of an optical film.

Here, the optical film is a film having an optical property, and examples thereof include a polarizing film, phase retardation film and the like.

The polarizing film is an optical film having a function of emitting polarization against incidence light such as natural light and the like. Examples of the polarizing film include a straight line polarizing film absorbing straight line polarization on a vibration place parallel to an optical axis and allowing permeation of straight light polarization having a vibration plane which is a vertical plane, a polarizing separation film reflecting straight line polarization on a vibration plane parallel to an optical axis, an elliptic polarizing film obtained by laminating a polarizing film and a phase retardation film described later. As the specific examples of the polarizing film, those in which dichroic coloring matters such as iodine, dichroic dyes and the like are adsorbed and oriented in an uni-axially stretched polyvinyl alcohol film mono-axially drawn, and the like are listed.

The phase retardation film is an optical film having mono-axial or di-axial optical anisotropy, and listed are stretched films obtained by stretching at about 1.01 to 6-fold a polymer film composed of polyvinyl alcohol, polycarbonate, polyester, polyallylate, polyimide, polyolefin, polystyrene, polysulfone, polyether sulfone, polyvinylidene fluoride/polymethyl methacryalte, liquid crystal polyester, acetylcellulose, cyclic polyolefin, ethylene-vinyl acetate copolymer saponified material, polyvinyl chloride and the like. Among them, polymer films obtained by uni-axial or bi-axial stretching of polycarbonate or polyvinyl alcohol are preferably used.

Examples of the phase retardation film include a uni-axial phase retardation film, wide viewing angle phase retardation film, low photo-elastic phase retardation film, temperature-compensated phase retardation film, LC film (rod-like liquid crystal twisted orientation), WV film (disc-like liquid crystal inclined orientation), NH film (rod-like liquid crystal inclined orientation), VAC film (complete bi-axial orientation type phase retardation film), new VAC film (bi-axial orientation type phase retardation film) and the like.

On the above-mentioned optical film, a protective film may be further applied. Examples of the protective film include films composed of acrylic resins different from the acrylic resin of the present invention, acetylcellulose-based films such as a cellulose triacetate film and the like, polyester resin films, olefin resin films, polycarbonate resin films, polyether ketone resin films, polysulfone resin films and the like. In the protective film, ultraviolet absorbers such as a salicylate-based compound, benzophenone-based compound, benzotriazole-based compound, triazine-based compound, cyanoacrylate-based compound, nickel complex salt-based compound and the like may be compounded. In the protective films, acetylcellulosed-based films are suitably used.

The optical laminate of the present invention is obtained by laminating a glass base plate on an adhesive layer of an optical laminated film. Here, examples of the glass base plate include a glass base plate of liquid crystal cell, non-glaring glass, glass for sunglasses, and the like. Among them, an optical laminate obtained by laminating an optical laminated film (upper plate polarization plate) on a upper glass base plate of a liquid crystal cell, and laminating another optical laminated film (lower plate polarization plate) on a lower glass base plate of a liquid crystal cell is preferable since it can be used as a liquid crystal display. As the material of a glass base plate, for example, soda lime glass, low-alkali glass, non-alkali glass and the like are listed.

As the method for producing an optical laminated film and an optical laminate, there are listed, for example, a method in which an adhesive is laminated on a release film, an optical film is further laminated on the resulted adhesive layer, then, the release film is peeled to obtain an optical laminated film, subsequently, the adhesive layer and a surface of a glass base plate are laminated to produce an optical laminate; a method in which an adhesive is laminated on an optical film, and release film is applied to produce a protected optical laminated film, and in lamination on a surface of a glass base plate, the release film is peeled from the optical laminated film, and the adhesive layer and a surface of a glass base plate are laminated to produce an optical laminate; and the like. Here, as the release film, there are mentioned, for example, those obtained by using as a base material a film composed of various resins such as polyethylene terephthalate, polybutylene terephthalate, polycarbonate, polyallylate and the like, and performing releasing treatment (silicone treatment and the like) on a surface to be connected to an adhesive layer of this base material.

Even after peeling of an optical laminated film from the optical laminate of the present invention, fogging and paste remaining and the like scarcely occur on the surface of a glass base material in contact with an adhesive layer, consequently, it is easy to apply an optical laminated film again on the peeled glass base plate, therefore, a so-called re-working property is excellent.

According to the present invention, optical defects derived from non-uniform stress distribution are prevented, therefore, it is possible to provide an acrylic resin composition imparting an optical laminated film capable of producing a liquid crystal cell in which light leakage is suppressed when a glass base plate is a TN liquid crystal cell (TFT), and in case of a glass base plate being a STN liquid crystal cell, non-uniformity of color is suppressed.

The acrylic resin composition of the present invention is excellent in flexibility and shows excellent adhesion with an optical film and the like, therefore, those containing the above-mentioned acrylic resin composition and cross-linking agent and/or silane compound can be suitably used as an adhesive.

An optical laminated film laminating an adhesive layer composed of the above-mentioned adhesive and an optical film can be laminated on a glass base plate of a liquid crystal cell to produce an optical laminate of the present invention.

In such an optical laminate, the adhesive layer absorbs and relaxes stress derived from the dimension change of the optical film and glass base plate under heat and humidity conditions, therefore, local stress concentration is decreased, and peeling of the adhesive layer from the glass base plate is suppressed. Further, since optical defects caused by non-uniform stress distribution are prevented, when the glass base plate is a TN liquid crystal cell (TNT), light leakage is suppressed, and when the glass base plate is a STN liquid crystal cell, non-uniformity of color is suppressed. Furthermore, since a re-working property is excellent, even if an optical laminated film once laminated is peeled from the glass base plate of the optical laminate, paste remaining and fogging on the surface of the glass base plate after peeling are suppressed, and it can be again used as a glass base plate.

The acrylic resin composition of the present invention can be used for, for example, an adhesive, paint, thickening agent and the like. The adhesive of the present invention can be used, for example, as an adhesive suitable for an optical laminate of a liquid crystal cell and the like.

### EXAMPLES

The present invention will be further described using examples. In the examples, parts and % are by weight unless otherwise stated. The content of non-volatile components was measured according to JIS K-5407. Specifically, an optional weight of adhesive solution was placed on a Petri dish, and dried in an explosion protection oven at 115° C. for 2 hours, then, the weight of remaining non-volatile components was divided by the weight of the originally weighed solution. The viscosity is a value measured by a Brook field viscometer at 25° C. Measurement of the weight-average molecular weight by a light scattering method of GPC was conducted using a GPC apparatus equipped with a light scattering photometer and differential refractometer as a detector, under conditions of a sample concentration of 5 mg/ml, a sample introduction amount of 100 μml, a column temperature of 40° C. and a flow rate of 1 ml/min, and using tetrahydrofuran as an eluent. For measurement of the weight-average molecular weight in terms of polystyrene, a sample and standard polystyrene were measured under the same GPC conditions, and the molecular weight was converted from the retained volume.

<Production Example of Acrylic Resin>

### (Polymerization Example 1)

Into a reactor equipped with a cooling tube, nitrogen introduction tube, thermometer and stirrer was charged 222 parts of ethyl acetate, air in the apparatus was purged with a nitrogen gas to make no-oxygen atmosphere, then, the inner temperature was raised to 70° C. 0.65 parts of azobisisobutyronitrile (hereinafter, referred to as AIBN) was dissolved in 12.5 parts of ethyl acetate and the prepared solution was all added to the reactor, then, a mixed solution of 93.9 parts of butyl acrylate as a monomer (a), 4.3 parts of N-vinyl-2-pyrrolidone as a monomer (b) and 1.8 parts of tripropylene glycol diacrylate as a monomer (c) were dropped into the reaction system over 3 hours while keeping the inner temperature at 69 to 71° C. Thereafter, the reaction was completed while keeping the inner temperature at 69 to 71° C. for 5 hours. The content of non-volatile components in the resulted acrylic resin solution was regulated to 30%, to find a viscosity of 212 mPa·s. The weight-average molecular weight according to GPC light scattering method was about 4260000, and the weight-average molecular weight in terms of polystyrene was 482000.

### (Polymerization Example 2)

The reaction was completed in the same manner as in Polymerization Example 1 except that 85.1 parts of butyl acrylate was used as a monomer (a) and 13.1 parts of N-vinyl-2-pyrrolidone was used as a monomer (b). The content of non-volatile components in the resulted acrylic resin solution was regulated to 30%, to find a viscosity of 235 mPa·s. The weight-average molecular weight according to GPC light scattering method was about 2510000, and the weight-average molecular weight in terms of polystyrene was 314000.

### (Polymerization Example 3)

The reaction was completed in the same manner as in Polymerization Example 1 except that 92.8 parts of butyl acrylate was used as a monomer (a) and 5.4 parts of acryloylmorpholine was used as a monomer (b). The content of non-volatile components in the resulted acrylic resin solution was regulated to 30%, to find a viscosity of 172 mPa·s. The weight-average molecular weight according to GPC light scattering method was about 2740000, and the weight-average molecular weight in terms of polystyrene was 442000.

### (Polymerization Example 4)

The reaction was completed in the same manner as in Polymerization Example 1 except that 92.3 parts of butyl acrylate was used as a monomer (a), 6 parts of tetrahydrofurfuryl acrylate was used as a monomer (b) and 1.7 parts of tripropylene glycol diacrylate was used as a monomer (c). The content of non-volatile components in the resulted acrylic resin solution was regulated to 30%, to find a viscosity of 121 mPa·s. The weight-average molecular weight according to GPC light scattering method was about 1480000, and the weight-average molecular weight in terms of polystyrene was 396000.

### (Polymerization Example 5)

The reaction was completed in the same manner as in Polymerization Example 1 except that 93.6 parts of butyl acrylate was used as a monomer (a), 4.3 parts of N-vinyl-2-pyrrolidone was used as a monomer (b) and 1.8 parts of tripropylene glycol diacrylate was used as a monomer (c), and additionally, 0.28 parts of acrylic acid was used as a monomer (e). The content of non-volatile components in the resulted acrylic resin solution was regulated to 30%, to find a viscosity of 122 mPa·s. The weight-average molecular weight according to GPC light scattering method was about 1240000, and the weight-average molecular weight in terms of polystyrene was 321000.

### (Polymerization Example 6)

The reaction was completed in the same manner as in Polymerization Example 1 except that 180.0 parts of butyl acrylate, 40.9 parts of isobutyl methacrylate were used as a monomer (a), 26.7 parts of vinylcaprolactam was used as a monomer (b), 4.4 parts of tripropylene glycol diacrylate was used as a monomer (c) and 3.9 parts of isobornyl acrylate was used as a monomer (d). The content of non-volatile components in the resulted acrylic resin solution was regulated to 30%, to find a viscosity of 172 mPa·s. The weight-average molecular weight according to GPC light scattering method was about 2741000, and the weight-average molecular weight in terms of polystyrene was 387500.

### (Polymerization Example 7)

Into a reactor equipped with a cooling tube, nitrogen introduction tube, thermometer and stirrer was charged 184 parts of ethyl acetate, air in the apparatus was purged with a nitrogen gas to make no-oxygen atmosphere, then, the inner temperature was raised to 70° C. 0.63 parts of AIBN was dissolved in 10.0 parts of ethyl acetate and the prepared solution was all added to the reactor, then, a mixed solution of 65.0 parts of butyl acrylate and 8.9 parts of isobutyl acrylate as a monomer (a), 6.1 parts of vinylcaprolactam as a monomer (b), 1.3 parts of isobonyl acrylate as a monomer (d) and 1.4 parts of tripropylene glycol diacrylate as a monomer (c) was dropped into the reaction system over 3 hours while keeping the inner temperature at 69 to 71° C. Thereafter, the reaction was completed while keeping the inner temperature at 69 to 71° C. for 5 hours. The content of non-volatile components in the resulted acrylic resin solution was regulated to 30%, to find a viscosity of 381 mPa·s. The weight-average molecular weight according to GPC light scattering method was about 2120000, and the weight-average molecular weight in terms of polystyrene was 367000.

### (Polymerization Example 8)

The reaction was completed in the same manner as in Polymerization Example 7 except that 192.3 parts of ethyl acetate, 0.65 parts of AIBN were used, 65.0 parts of butyl acrylate and 9.2 parts of isobutyl acrylate were used as a monomer (a), 9.0 parts of vinylcaprolactam was used as a monomer (b), 1.3 parts of isobornyl acrylate was used as a monomer (d) and 1.5 parts of tripropylene glycol diacrylate was used as a monomer (c). The content of non-volatile components in the resulted acrylic resin solution was regulated to 30%, to find a viscosity of 153 mPa·s. The weight-average molecular weight according to GPC light scattering method was about 2010000, and the weight-average molecular weight in terms of polystyrene was 343000.

### (Polymerization Example 9)

The reaction was completed in the same manner as in Polymerization Example 7 except that 1155.7 parts of ethyl acetate, 3.2 parts of AIBN were used, 450.0 parts of butyl acrylate and 19.9 parts of methyl methacrylate were used as a monomer (a), 22.1 parts of N-vinyl-2-pyrrolidone was used as a monomer (b), 8.2 parts of isobornyl acrylate was used as a monomer (d) and 9.1 parts of tripropylene glycol diacrylate was used as a monomer (c). The content of non-volatile components in the resulted acrylic resin solution was regulated to 30%, to find a viscosity of 258 mPa·s. The weight-average molecular weight according to GPC light scattering method was about 4170000, and the weight-average molecular weight in terms of polystyrene was 483000.

### (Polymerization Example 10)

The reaction was completed in the same manner as in Polymerization Example 7 except that 185.0 parts of ethyl acetate, 0.58 parts of AIBN were used, 60.0 parts of butyl acrylate and 3.2 parts of methyl methacrylate were used as a monomer (a), 13.4 parts of acryloylmorpholine was used as a monomer (b), 6.5 parts of isobornyl acrylate was used as a monomer (d) and 1.4 parts of tripropylene glycol diacrylate was used as a monomer (c). The content of non-volatile components in the resulted acrylic resin solution was regulated to 30%, to find a viscosity of 162 mPa·s. The weight-average molecular weight according to GPC light scattering method was about 3080000, and the weight-average molecular weight in terms of polystyrene was 430000.

### (Polymerization Example 11)

Into the same reactor as in Polymerization Example 1 was charged 96 parts of ethyl acetate, 98 parts of butyl acrylate as a monomer (a) and 1.1 parts of 4-hydroxybutyl acrylate as a monomer (e), air in the apparatus was purged with a nitrogen gas to make no-oxygen atmosphere, then, the inner temperature was raised to 55° C. 0.018 parts of 2,2′-azobis(2,4-dimethylvaleronitrile) was dissolved in 4 parts of ethyl acetate and the prepared solution was all added to the reactor, then, heat-insulated for 3 hours while keeping the inner temperature at 54 to 56° C. In this point, the concentration of monomers was 50%. Then, ethyl acetate was added every 3 hours so that the total concentration of the charged monomers (a) and (e) was decreased by 5%, and heat was insulated further for 3 hours when the monomer concentration reached 15%, to complete the reaction. The content of non-volatile components in the resulted acrylic resin solution 15.4%, and the viscosity was 6350 mPa·s. The weight-average molecular weight according to GPC light scattering method was about 3740000, and the weight-average molecular weight in terms of polystyrene was 1350000.

### (Polymerization Example 12)

The reaction was completed in the same manner as in Polymerization Example 1 except that 98.2 parts of a monomer (a) and 1.8 parts of a monomer (c) were used and a monomer (b) was not used. The content of non-volatile components in the resulted acrylic resin solution was regulated to 30%, to find a viscosity of 251 mPa·s. The weight-average molecular weight according to GPC light scattering method was about 2250000, and the weight-average molecular weight in terms of polystyrene was 559000.

### (Polymerization Example 13)

The reaction was completed in the same manner as in Polymerization Example 11 except that 93.7 parts of butyl acrylate was used as a monomer (a), 4.3 parts of N-vinylpyrrolidone was used as a monomer (b) and 2.0 parts of 4-hydroxybutyl acrylate was used as a monomer (e). The content of non-volatile components in the resulted acrylic resin solution 19.4%, and the viscosity was 51600 mPa·s. The weight-average molecular weight according to GPC light scattering method was about 3768000, and the weight-average molecular weight in terms of polystyrene was 1466000.

<Acrylic Resin Composition and Production Example of Adhesive Containing the Same Composition>

### (Example 1)

The acrylic resin solution obtained in Polymerization Example 1 was used as a solution of an acrylic resin (1), the acrylic resin solution obtained in Polymerization Example 11 was used as a solution of an acrylic resin (2) and they were mixed so that the content of non-volatile components in the acrylic resin (1) was 60 parts and the content of non-volatile components in the acrylic resin (2) was 40 parts, to obtain an ethyl acetate solution of acrylic resin composition having a non-volatile component content of 19.5%. The viscosity of the solution was 3540 mPa·s. To 100 parts of non-volatile components in the resulted solution was mixed 0.13 parts of non-volatile components of a polyisocyanate-based compound (trade name: CORONATE L, manufactured by Nippon Polyurethane Industry Co., Ltd.) and 0.2 parts of a silane-based compound (trade name: KBM-403, manufactured by Shin-Etsu Silicones) as a cross-linking agent, to obtain an adhesive of the present invention.

<Production Examples of Optical Laminated Film, and Optical Laminate>

Thus obtained adhesive was applied, using an applicator, on a releasing-treated surface of a polyethylene terephthalate film (manufactured by LINTEC Corporation, trade name: PET 3811) which had been subjected to releasing treatment so that the thickness after drying was 25 μm, the dried at 90° C. for 1 minute, to obtain an adhesive in the form of sheet. Then, a polarizing film (film having a three-layer structure obtained by adsorbing iodine into polyvinyl alcohol and stretching to obtain a stretched film and sandwiching said stretched film on both surfaces thereof by triacetylcellulose-based protective films) was used as an optical film, and a surface having the adhesive obtained above was applied on this optical film by a laminator, then, aged under a temperature of 40° C. and a humidity of 50% for 14 days, to obtain an optical laminated film having an adhesive layer. Subsequently, this optical laminated film was adhered on both surfaces of a glass base plate for liquid crystal cell (manufactured by Corning, 1737) so as to give Cross Nicol condition. This was preserved under 80° C. and dry condition for 96 hours (condition 1) and preserved under 60° C. and 90% RH for 96 hours (condition 2), and durability of the optical laminate and light leakage after preservation were observed visually. The results are classified as described below and shown in Table 1.

<Light Leakage Property of Optical Laminate>

Evaluation of state of generation of light leakage was conducted according to the following four stages.
⊚: no light leakage
◯: little light leakage
Δ: slight light leakage
X: remarkable light leakage
   <Durability of Optical Laminate>

Evaluation of durability was conducted according to the following four stages.
⊚: no change in appearance such as floating, peeling, foaming and the like
◯: little change in appearance such as floating, peeling, foaming and the like
Δ: slight change in appearance such as floating, peeling, foaming and the like
X: remarkable change in appearance such as floating, peeling, foaming and the like
   <Re-Working Property>

Evaluation of the re-working property was conducted as described below. First, the above-mentioned optical laminate was processed into a specimen of 25 mm×150 mm. Then, this specimen was pasted on a glass base plate for liquid crystal cell (manufactured by Corning, 1737) using a pasting apparatus (“Lamipacker”, manufactured by Fuji Plastic Machine K.K.), and treated in an autoclave under 50° C., 5 kg/cm² (490.3 kPa) for 20 minutes. Subsequently, the optical laminate for peeling test was preserved in an atmosphere of 23° C. and 50% RH for 720 hours, then, this pasted specimen was peeled toward 180Ω direction at a rate of 300 mm/min in an atmosphere of 23° C. and 50% RH, and the state of the surface of the glass plate classified according to the following conditions was observed and shown in Table 1.
⊚: very good, ◯: good, Δ: moderate, X: poor

### (Examples 2 to 6 and Comparative Examples 1 to 3)

An acrylic resin composition, adhesive, optical laminated film and optical laminate were produced according to Example 1 using the acrylic resins (1) and (2) at weight ratios shown in Tables 1 and 2. Evaluation of the resulted optical laminate was conducted in the same manner as in Example 1, and the results are shown in Tables 1 and 2 together with that of Example 1. In Comparative Example 1, an adhesive composed of an acrylic resin composition containing no structural unit (b) in an acrylic resin (1) was used, and in Comparative Examples 2 and 3, an adhesive composed only of an acrylic resin (2) was used.

TABLE 1

| | | Example | | | | | | | | | |
|---|---|---|---|---|---|---|---|---|---|---|---|
| | | 1 | 2 | 3 | 4 | 5 | 6 | 7 | 8 | 9 | 10 |
| Acrylic | Polymerization example | 1 | 2 | 3 | 4 | 5 | 6 | 7 | 8 | 9 | 10 |
| resin (1) | Non-volatile component | 40 | 40 | 40 | 40 | 40 | 40 | 40 | 40 | 40 | 40 |
| | content (part by weight) | | | | | | | | | | |
| | (a)^{*1} | 93.9 | 85.1 | 92.8 | 92.3 | 93.6 | 86.3 | 89.3 | 86.3 | 92.3 | 74.8 |
| | (part by weight) | | | | | | | | | | |
| | (b)^{*1} | 4.3 | 13.1 | 5.4 | 6.0 | 4.3 | 10.4 | 7.4 | 10.5 | 4.3 | 15.8 |
| | (part by weight) | | | | | | | | | | |
| | (c)^{*1} | 1.8 | 1.8 | 1.8 | 1.7 | 1.8 | 1.7 | 1.7 | 1.7 | 1.8 | 1.7 |
| | (part by weight) | | | | | | | | | | |
| | (d)^{*1} | 0 | 0 | 0 | 0 | 0 | 1.6 | 1.6 | 1.5 | 1.6 | 7.7 |
| | (part by weight) | | | | | | | | | | |
| | (e)^{*1} | 0 | 0 | 0 | 0 | 0.3 | 0 | 0 | 0 | 0 | 0 |
| | (part by weight) | | | | | | | | | | |
| Acrylic | Polymerization example | 11 | 11 | 11 | 11 | 11 | 11 | 11 | 11 | 11 | 11 |
| resin | Non-volatile component | 60 | 60 | 60 | 60 | 60 | 60 | 60 | 60 | 60 | 60 |
| (2)^{*3} | content (part by weight) | | | | | | | | | | |
| | (a)^{*2} | 98.9 | 98.9 | 98.9 | 98.9 | 98.9 | 98.9 | 98.9 | 98.9 | 98.9 | 98.9 |
| | (part by weight) | | | | | | | | | | |
| | (e)^{*2} | 1.1 | 1.1 | 1.1 | 1.1 | 1.1 | 1.1 | 1.1 | 1.1 | 1.1 | 1.1 |
| | (part by weight) | | | | | | | | | | |
| Acrylic | Non-volatile component | 19.5 | 19.6 | 20.4 | 19.8 | 19.1 | 21.2 | 22.3 | 20.2 | 21.8 | 21.4 |
| resin | content (wt %) | | | | | | | | | | |
| compo- | Viscosity (mPa · s) | 3540 | 3560 | 3700 | 3550 | 3400 | 3870 | 4190 | 3660 | 4040 | 3910 |
| sition | | | | | | | | | | | |
| Condi- | Durability | ⊚ | ⊚ | ⊚ | ⊚ | ⊚ | ⊚ | ⊚ | ⊚ | ⊚ | ⊚ |
| tion 1 | Light leakage property | ⊚ | ⊚ | ⊚ | ⊚ | ⊚ | ⊚ | ⊚ | ⊚ | ◯ | ⊚ |
| Condi- | Durability | ◯ | ◯ | ◯ | ◯ | ◯ | ⊚ | ⊚ | ⊚ | ⊚ | ⊚ |
| tion 2 | Light leakage property | ⊚ | ⊚ | ⊚ | ⊚ | ⊚ | ⊚ | ◯ | ◯ | ◯ | ◯ |
| re- | Paste remaining property | ⊚ | ⊚ | ⊚ | ⊚ | ⊚ | ⊚ | ⊚ | ⊚ | ⊚ | ⊚ |
| working | | | | | | | | | | | |
| property | | | | | | | | | | | |

^{*1}Parts by weight of structural units (a) + (b) + (c) + (d) + (e) = 100 (parts by weight)
^{*2}Parts by weight of structural units (a) + (e) = 100 parts by weight
^{*3}Containing no structural units (b) + (c)

TABLE 2

| | | Comparative example | | |
|---|---|---|---|---|
| | | 1*³ | 2*³ | 3 |
| Acrylic | Polymerization example | 12 | — | — |
| resin (1) | Non-volatile component | 40 | — | — |
| | content (part by weight) | | | |
| | (a)*¹ | 98.2 | — | — |
| | (part by weight) | | | |
| | (b)*¹ | 0 | — | — |
| | (part by weight) | | | |
| | (c)*¹ | 1.8 | — | — |
| | (part by weight) | | | |
| | (e)*¹ | 0 | — | — |
| | (part by weight) | | | |
| Acrylic | Polymerization example | 11 | 11 | 13 |
| resin (2)*³ | Non-volatile component | 60 | 100 | 100 |
| | content (part by weight) | | | |
| | (a)*² | 98.9 | 98.9 | 93.7 |
| | (part by weight) | | | |
| | (b)*² | 0 | 0 | 4.3 |
| | (part by weight) | | | |
| | (e)*² | 1.1 | 1.1 | 2.0 |
| | (part by weight) | | | |
| Acrylic | Non-volatile component | 20.0 | 15.4 | 19.4 |
| resin | content (wt %) | | | |
| composition | Viscosity (mPa · s) | 3660 | 6350 | 51600 |
| Condition 1 | Durability | ◯ | ◯ | ◯ |
| | Light leakage property | Δ | X | X |
| Condition 2 | Durability | ◯ | ◯ | ◯ |
| | Light leakage property | Δ | X | X |
| re-working | Paste remaining property | ⊚ | ⊚ | ◯ |
| property | | | | |

*¹Parts by weight of structural units (a) + (c) = 100 (parts by weight)
*²Parts by weight of structural units (a) + (b) + (e) = 100 parts by weight
*³Acrylic resin (2) contains no structural units (b) + (c)

1. An acrylic resin composition comprising the following acrylic resins (1) and (2):
acrylic resin (1): an acrylic resin containing a structural unit derived from a monomer (a) (structural unit (a)), a structural unit derived from a monomer (b) (structural unit (b)) and a structural unit derived from a monomer (c) (structural unit (c)) and containing the structural unit (c) in an amount of 0.05 to 5 parts by weight based on 100 parts by weight of the acrylic resin (1);
acrylic resin (2): a straight chain acrylic resin containing the structural unit (a) as the main component;
(a): a (meth)acrylate of the formula (A) 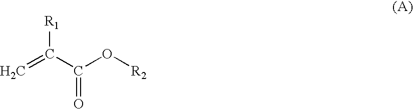
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.),
(b): a monomer containing an olefinic double bond in the molecule and at least one 5- or more-membered heterocyclic group in the molecule,
(c): a monomer containing at least two olefinic double bonds in the molecule.

2. The composition according to claim 1, wherein the acrylic resin (2) is an acrylic resin containing substantially no structural unit (c).

3. The composition according to claim 1, wherein the content of the structural unit (a) in the acrylic resin (1) is from 15 to 99.85 parts by weight based on 100 parts by weight of the acrylic resin (1).

4. The composition according to claim 1, wherein the content of the structural unit (b) in the acrylic resin (1) is from 0.1 to 30 parts by weight based on 100 parts by weight of the acrylic resin (1).

5. The composition according to claim 1, wherein the monomer (b) is at least one selected from the group consisting of N-vinylpyrrolidone, vinylcaprolactam and acryloylmorpholine.

6. The composition according to claim 1, wherein the acrylic resin (1) is an acrylic resin further containing a structural unit derived from a monomer (d):
(d): a monomer different from (a) to (c) and containing one olefinic double bond and at least one alicyclic structure in the molecule.

7. The composition according to claim 1, wherein the acrylic resin (1) and/or (2) further contains a structural unit derived from a monomer (e):
(e): a monomer different from (a) to (d) and containing at least one polar functional group selected from the group consisting of a carboxyl group, hydroxyl group, amide group, amino group, epoxy group, oxetanyl group, aldehyde group and isocyanate group and one olefinic double bond in the molecule.

8. The composition according to claim 1, wherein the monomer (c) is a monomer containing in the molecule at least two (meth)acryloyl groups of the formula (B): 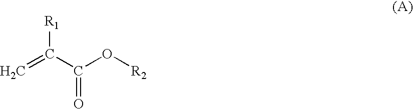
(wherein, R₃ represents a hydrogen atom or methyl group.).

9. The composition according to claim 1, wherein the amount of the acrylic resin (1) is 5 to 50 parts by weight based on 100 parts by weight of the total amount of the acrylic resin (1) and the acrylic resin (2).

10. An adhesive comprising the composition according to claim 1 and a cross-linking agent and/or silane-based compound.

11. An optical laminated film laminating an adhesive layer composed of the adhesive according to claim 10 on both surfaces or one surface of an optical film.

12. The optical laminated film according to claim 11, wherein the optical film is a polarizing film and/or phase retardation film.

13. The optical laminated film according to claim 11 wherein the optical film is an optical film further having an acetylcellulose-based film as a protective film.

14. The optical laminated film according to claim 11, wherein a release film is further laminated on the adhesive layer of the optical laminated film.

15. An optical laminate obtained by laminating a glass base material on the adhesive layer of the optical laminated film according to claim 11.

16. An optical laminate obtained by peeling the release film from the optical laminated film according to claim 14, then, laminating a glass base material on the adhesive layer of the optical laminated film.

17. An optical laminate obtained by peeling the optical laminated film from the optical laminate according to claim 15, then, laminating again the optical laminated film on the resulted glass base material.
